(19) United States
(12) Patent Application Publication
(10) Pub. No.: US 2015/0103072 A1
(43) Pub. Date: Apr. 16, 2015

(54) METHOD, APPARATUS, AND RECORDING MEDIUM FOR RENDERING OBJECT

(71) Applicant: Samsung Electronics Co., Ltd., Suwon-si (KR)

(72) Inventors: Min-young SON, Hwaseong-si (KR); Kwon-taek KWON, Seoul (KR); Min-kyu JEONG, Yongin-si (KR)

(73) Assignee: SAMSUNG ELECTRONICS CO., LTD., Suwon-si (KR)

(21) Appl. No.: 14/276,083

(22) Filed: May 13, 2014

(30) Foreign Application Priority Data
Oct. 10, 2013 (KR) 10-2013-0120870

(51) Int. Cl. G06T 15/00; G06K 9/62; G06T 11/00

(52) U.S. Cl. CPC G06T 15/00; G06T 11/001; G06K 9/6202
USPC 345/419

(57) ABSTRACT

Provided is a method of rendering an object. The method includes rendering extracting transparency information, at a object rendering apparatus, from a plurality of fragments, which comprise information representing at least one object in a frame, comparing depth information of at least one fragment, from among the plurality of fragments, located at a position of the frame, and determining a rendering of at least one fragment that is located in the position based on the comparison of the depth information and the transparency information.

### RELATED APPLICATIONS

This application claims the benefit under 35 USC 119(a) of Korean Patent Application No. 10-2013-0120870, filed on Oct. 10, 2013, in the Korean Intellectual Property Office, the entire disclosure of which is incorporated herein by reference for all purposes.

### BACKGROUND

1. Field

The following description relates to methods and apparatuses for rendering an object, and a recording medium for performing the same.

2. Description of Related Art

Devices for displaying three-dimensional (3D) graphics data on a screen are increasingly being used. For example, devices using a user interface (UI) application for a mobile device or an application for a simulation are expanding.

A device for displaying 3D graphics data on a screen generally includes a graphic processing unit (GPU). A GPU renders fragments that represent an object on a display. A GPU receives one or more fragment values for each fragment on a display.

A GPU may determine a fragment value by blending one or more fragment values, which it receives to display 3D graphics data on a screen, and may output the blended values on a screen.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect there is provided a rendering method, including extracting transparency information, at a object rendering apparatus, from a plurality of fragments, which comprise information representing at least one object in a frame, comparing depth information of at least one fragment, from among the plurality of fragments, located at a position of the frame, and determining a rendering of at least one fragment that is located in the position based on the comparison of the depth information and the transparency information.

The determining of the rendering may include extracting a first fragment that is located at a nearest depth from among the at least one fragment that is located in the position based on the comparison of the depth information, and determining a rendering of a second fragment that is located at a farther depth than the first fragment based on transparency information of the first fragment.

The determining of the rendering of the second fragment may include removing the second fragment in response to transparency of the first fragment being equal to or less than a value.

The determining of the rendering of the second fragment comprises selecting the rendering of the second fragment from among a plurality of rendering methods, wherein the plurality of rendering methods are classified based on transparency information of a fragment that is located in a nearer depth than the predetermined fragment.

The rendering method may include storing the extracted transparency information in a transparency buffer for each fragment.

The rendering method may include obtaining a plurality of fragments, which comprise information for representing at least one object in a frame.

The rendering method may include storing the extracted transparency information in a transparency buffer as transparency information for each of the plurality of fragments in the frame, and determining a rendering of each of a plurality of fragments, which represent the object in a second frame based on the stored transparency information.

The rendering method may include extracting transparency information, which corresponds to the plurality of fragments for representing the object in the second frame, from the transparency buffer, and determining a method of rendering each of the plurality of fragments representing the object in the second frame based on the extracted transparency information.

The determining of the rendering may include extracting a first fragment and second fragment that is located at a nearest depth from among the at least one fragment that is located in the position based on the comparison of the depth information, and determining a rendering of a third fragment that is located at a farther depth than the first fragment and the second fragment based on a sum of transparency information of the first fragment and the second fragment.

In another general aspect there is provided a rendering method, including extracting transparency information, at a object rendering apparatus, from a plurality of fragments that comprise information representing at least one object in a frame, determining rendering of each of a plurality of fragments that comprise information representing a object in a second frame based on each of the extracted transparency information.

In another general aspect there is provided a rendering apparatus including a transparency information extractor configured to extract transparency information from a plurality of fragments, which comprise information to represent at least one object in a frame, a depth information comparer configured to compare depth information of at least one fragment, from among the plurality of fragments, located at a position of the frame, and a determiner configured to determine a rendering of at least one fragment that is located in the same position based on the comparison of the depth information and the transparency information.

The determiner may be further configured to extract a first fragment that is located in a nearest depth, from among the at least one fragment based on the result of the comparing of the depth information, and determine rendering of a second fragment that is located at a farther depth than the first fragment based on transparency information of the first fragment.

The determiner may be further configured to remove the second fragment in response to the transparency of the first fragment being equal to or less than a value.

The determiner may be further configured to select the rendering of the second fragment from among a plurality of rendering methods, and the plurality of rendering methods are classified based on transparency information of a fragment that is located in a nearer depth than the predetermined fragment.

The rendering apparatus may include a transparency buffer configured to store the extracted transparency information for each fragment.

The rendering apparatus may include an input/output apparatus configured to obtain a plurality of fragments that comprise information for representing at least one object in a frame.

The determiner may be further configured to control a transparency buffer configured to store the extracted transparency information as transparency information for each of the plurality of fragments in the frame, and determine a method of rendering each of a plurality of fragments representing the object in a second frame based on the stored transparency information.

The determiner may be further configured to control the transparency information extractor to extract transparency information, which corresponds to the plurality of fragments for representing the object in the second frame, from the transparency buffer, and determine a method of rendering each of the plurality of fragments for representing the object in the second frame based on the extracted transparency information.

In another general aspect there is provided a rendering apparatus including a transparency information extractor configured to extract transparency information respectively from a plurality of fragments that comprise information for representing at least one object in a frame, and a determiner configured to determine rendering a plurality of fragments that comprise information for representing a object in a second frame based on each of the extracted transparency information.

Other features and aspects will be apparent from the following detailed description, the drawings, and the claims.

### BRIEF DESCRIPTION OF THE DRAWINGS

FIG. 1 is a diagram illustrating an example of a pipeline for performing three-dimensional (3D) graphics rendering.

FIG. 2 is a diagram illustrating an example of an object rendering method.

FIG. 3 is a diagram illustrating an example of a method of storing transparency information of a plurality of fragments in a transparency buffer.

FIG. 4 is a diagram illustrating an example of a method of rendering fragments that are located in the same location in a frame based on transparency, which is performed by an object rendering apparatus.

FIG. 5 is a diagram illustrating an example of a method of rendering fragments that are located in the same position in a frame, based on a rendering method that is classified according to transparency, which is performed by the object rendering apparatus.

FIG. 6 is a diagram illustrating an example of a method of using transparency information of a current frame to render a fragment for representing a predetermined object in a next frame.

FIGS. 7 and 8 are diagrams illustrating examples of the object rendering apparatus.

FIG. 9 is a diagram illustrating an example of a method of rendering a plurality of fragments in a next frame based on transparency information of a current frame.

FIG. 10 is a diagram illustrating an example of the object rendering apparatus.

Throughout the drawings and the detailed description, unless otherwise described, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of functions and constructions that are well known to one of ordinary skill in the art may be omitted for increased clarity and conciseness. The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

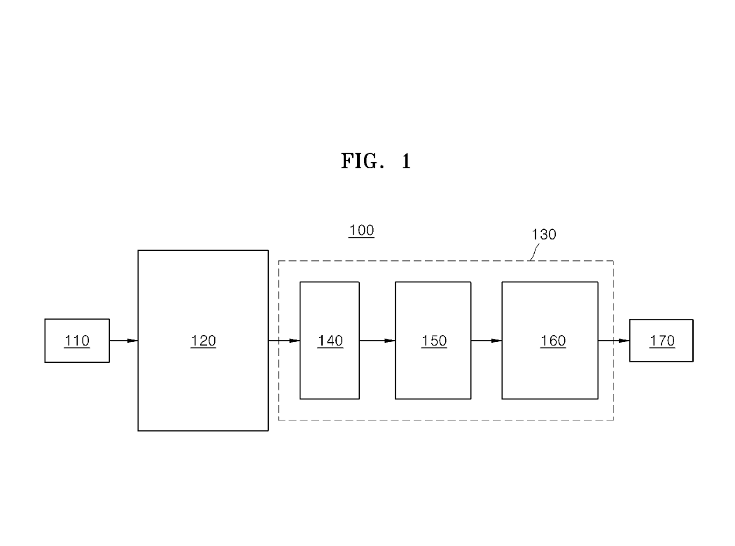

FIG. 1 is a diagram illustrating an example of a pipeline 100 for performing three-dimensional (3D) graphics rendering. While components related to the present example are illustrated in the pipeline 100 for performing three-dimensional (3D) graphics rendering of FIG. 1, it is understood that those skilled in the art may include other general components.

Referring to FIG. 1, the pipeline 100 may include a geometry operation unit 120 and a fragment operation unit 130. The geometry operation unit 120 may perform a phase transformation with respect to a vertex in a space. The geometry operation unit 120 may project a coordinate of a vertex on a screen. Based on coordinates of vertices that are projected on a screen by the geometry operation unit 120, the fragment operation unit 130 may generate a pixel in a polygon, for example, a triangle that is formed by the vertices. Additionally, the fragment operation unit 130 may compute colors of the generated pixels.

The geometry operation unit 120 may include a primitive processor, a vertex shader, and a primitive assembly. However, it is understood that those skilled in the art may include other general-use elements may be further included.

The primitive processor may receive data having an application-specific data structure from an application 110. The primitive processor may generate vertices based on the received data. The application 110 may be, for example, an application using 3D graphics, which may execute a video game, graphics, or a video conference.

The vertex shader may transform a 3D position of each vertex within a virtual space into a two-dimensional (2D) coordinate and a depth value of a Z buffer that are to be displayed on a screen.

The primitive assembly may collect vertex data that is output from the vertex shader, and generate a primitive that may be executed based on the collected vertex data, for example, a line, a point, a triangle, or the like.

The fragment operation unit 130 may include a rasterizer 140, an object rendering apparatus 150, and a pixel shader 160. However, it is understood that those skilled in the art may include other general-use elements may be further included.

By interpolating a screen coordinate and a text coordinate that are defined in each vertex within a primitive that is received from the geometry operation unit 120, the rasterizer 140 may generate fragment information about an inside of the primitive. In the following description and examples, the terms “fragment” and “pixel” may have the same meaning, and thus may be used interchangeably with each other.

The object rendering apparatus 150 may extract transparency from a plurality of fragments that include information for representing a primitive in a frame in advance. The object rendering apparatus 150 may determine a method of rendering a plurality of fragments, based on the transparency that is extracted in advance. For convenience of description, a primitive may be referred to as an object.

The pixel shader 160 may determine a color of a fragment, by computing texture mapping, light reflection, or the like with regard to each fragment in the frame. Additionally, the pixel shader 160 may remove a fragment that is unnecessary for representing an object on a frame, for example, a fragment of an object that is placed behind an opaque object among overlapping objects. Rendering may not be performed on the removed fragment.

The frame buffer 170 may be a video output apparatus for driving a video output from a memory buffer that includes a complete data frame.

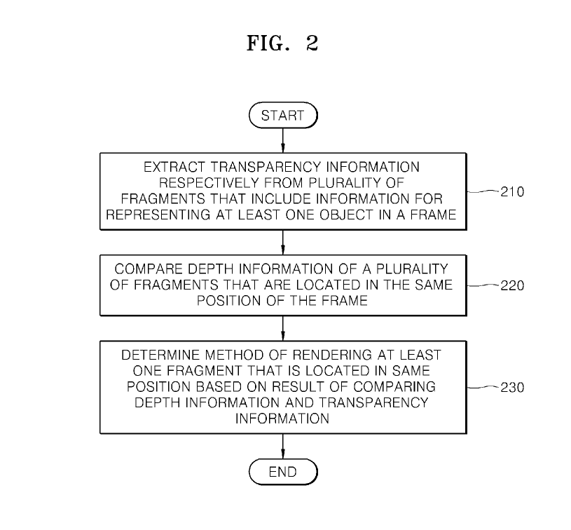

FIG. 2 is a diagram illustrating an example of an object rendering method. The operations in FIG. 2 may be performed in the sequence and manner as shown, although the order of some operations may be changed or some of the operations omitted without departing from the spirit and scope of the illustrative examples described. Many of the operations shown in FIG. 2 may be performed in parallel or concurrently.

In operation 210, the object rendering apparatus 150 may extract transparency information from a plurality of fragments that include information for representing at least one object in a frame.

The object rendering apparatus 150 may obtain a plurality of fragments with respect to at least one object. The object rendering apparatus 150 may determine whether transparency information is present with respect to the plurality of fragments. Based on determining whether transparency information is present, the object rendering apparatus 150 may transmit fragments that do not have transparency information to the fragment shader 160, so that a general rendering process may be performed.

The object rendering apparatus 150 may extract transparency information from fragments for which transparency information is present, and may store the extracted transparency information in a transparency buffer for each fragment.

In operation 220, the object rendering apparatus 150 may compare depth information for a plurality of fragments that are located in the same position of the frame.

A plurality of fragments, which are received by the object rendering apparatus 150, may include fragments that are located in the same position in a frame. For example, in the case of objects that overlap with each other in a 3D space, fragments that are located in an area in which objects overlap with each other may include the same position information in a frame.

The object rendering apparatus 150 may extract depth information from fragments that include the same position information. The object rendering apparatus 150 may compare the extracted depth information, and arrange fragments that include the same position information. For example, the object rendering apparatus 150 may arrange fragments, which includes the same position information, in an order of nearer depths of the fragments.

In operation 230, based on comparing the depth information and the transparency information, the object rendering apparatus 150 may determine a method of rendering at least one fragment that is located in the same position.

The object rendering apparatus 150 may extract a first fragment that is located in a nearest depth, based on the depth information. The object rendering apparatus 150 may identify transparency information of the first fragment. Based on the identified transparency information, the object rendering apparatus 150 may determine a method of rendering fragments that are located at a depth farther than the first fragment. For example, if the first fragment is opaque, the object rendering apparatus 150 may not perform rendering on fragments that are located in a farther depth. The object rendering apparatus 150 may remove fragments that are located in a far depth.

By extracting transparency information of a first fragment, the object rendering apparatus 150 may apply a preset rendering method from among a plurality of rendering methods to a second fragment that is located in a farther depth than the first fragment. The plurality of rending methods may be classified based on transparency information of fragments that are located in a nearer depth than a predetermined fragment.

For example, determining a method of rendering a second fragment, which is performed by the object rendering apparatus 150 when the transparency of a first fragment is 70 and when the transparency of a first fragment is 50 are compared. When transparency of the first fragment is 50, the object rendering apparatus 150 may select a low-precision rendering method as a method of rendering a second fragment, compared to when the transparency of the first fragment is 70. If transparency of the first fragment is low, the first fragment is more opaque. Since the second fragment, which is located at a farther depth, is covered by the first fragment, the second fragment may have a relatively little effect on representing an object in a frame, compared to the first fragment. Accordingly, when transparency of the first fragment is 50, the object rendering apparatus 150 may employ a low-precision rendering method to render a second fragment, where an amount of operation is comparatively small.

According to a non-exhaustive example, the object rendering apparatus 150 determines a method of rendering a plurality of fragments that are located in the same position, by extracting transparency information from a plurality of fragments in advance. Thus, the object rendering apparatus 150 may adjust an amount of operation that is performed to render fragments that are located at a farther depth from among a plurality of fragments.

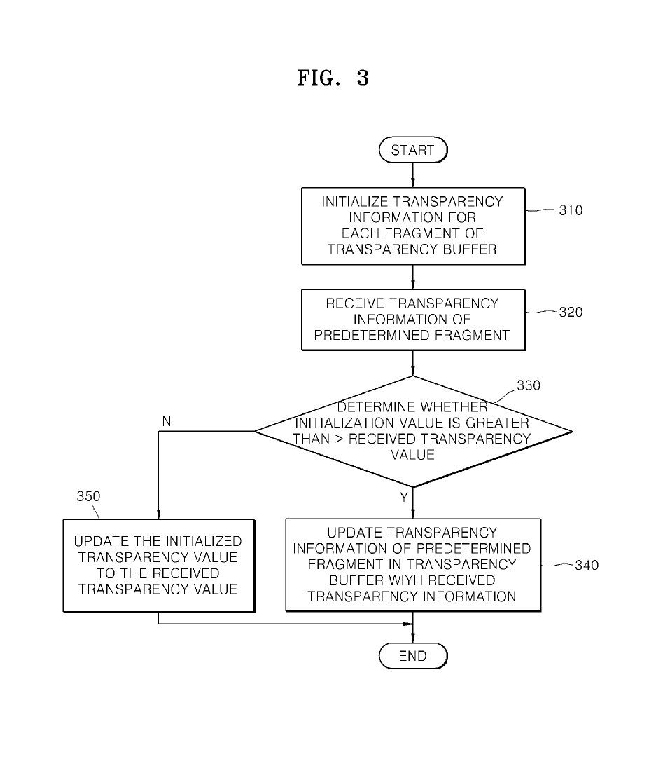

FIG. 3 is a diagram illustrating an example of a method of storing transparency information of a plurality of fragments in a transparency buffer. The operations in FIG. 3 may be performed in the sequence and manner as shown, although the order of some operations may be changed or some of the operations omitted without departing from the spirit and scope of the illustrative examples described. Many of the operations shown in FIG. 3 may be performed in parallel or concurrently.

In operation 310, the object rendering apparatus 150 may initialize transparency information of a transparency buffer for each fragment. The transparency information may include a transparency value that is obtained by quantifying a degree of transparency of an object according to preset criteria. For example, the object rendering apparatus 150 may initialize a transparency value of a transparency buffer as 100.

In operation 320, the object rendering apparatus 150 may receive transparency information of a predetermined fragment. In addition to the transparency information of the predetermined fragment, the object rendering apparatus 150 may receive identification information for identifying the predetermined fragment, from among a plurality of fragments for representing at least one object in a frame.

In operation 330, the object rendering apparatus 150 may compare the received transparency information of the predetermined fragment to transparency information that is initialized by the transparency buffer. For example, if the transparency information is quantified as a transparency value, the object rendering apparatus 150 may compare a received transparency value of the predetermined fragment to a transparency value that is initialized by the transparency buffer.

If the received transparency value of the predetermined fragment is greater than an initialized transparency value of the predetermined fragment, in operation 340, the object rendering apparatus 150 may store the received transparency information of the predetermined fragment in a space of the transparency buffer, which corresponds to the predetermined fragment. The object rendering apparatus 150 may distinguish the space that corresponds to the predetermined fragment from the transparency buffer, based on the received identification information of the predetermined fragment.

In operation 350, if the received transparency value of the predetermined fragment is less than an initialized transparency value of the predetermined fragment, the object rendering apparatus 150 may update the initialized transparency value to the received transparency value of the predetermined fragment.

According to another example, if the object rendering apparatus 150 receives transparency information of a fragment that is located in the same position in a frame as the predetermined fragment, the object rendering apparatus 150 may store the transparency information and depth information in the transparency buffer. If the object rendering apparatus 150 receives transparency information of a fragment that is located at a nearer depth than the predetermined fragment, based on the depth information and the transparency information that are stored in the transparency buffer with respect to the predetermined fragment, the object rendering apparatus 150 may compare the received transparency information to the stored transparency information. The object rendering apparatus 150 may update the transparency information based on the comparision.

For example, if a transparent value and depth information with respect to a fragment x is stored in the transparency buffer, the object rendering apparatus 150 may receive a transparency value of a fragment y that is located at a nearer depth than the fragment x. The object rendering apparatus 150 may compare the transparency value of the fragment y to the transparency value of the fragment x. If the transparency value of the fragment y is lower than the transparency value of the fragment x, the object rendering apparatus 150 may update the stored transparency value to the transparency value of the fragment y.

The object rendering apparatus 150 compares depth information, and thus updates a transparency value. Thus, based on a transparency value of a fragment that is located in a nearest depth, from among a plurality of fragments that are located in the same position of the frame, the object rendering apparatus 150 may determine a method of rendering fragments that are located at a farther depth.

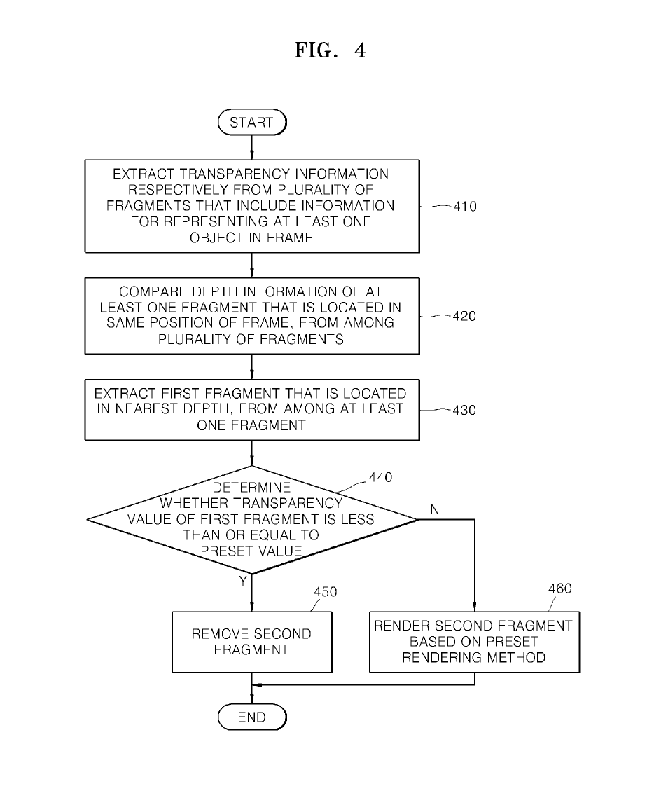

FIG. 4 is a diagram illustrating an example of a method of rendering fragments that are located in the same location in a frame based on transparency, which is performed by the object rendering apparatus 150. The operations in FIG. 4 may be performed in the sequence and manner as shown, although the order of some operations may be changed or some of the operations omitted without departing from the spirit and scope of the illustrative examples described. Many of the operations shown in FIG. 4 may be performed in parallel or concurrently.

In operation 410, the object rendering apparatus 150 may extract transparency information from a plurality of fragments that include information representing at least one object in a frame.

The object rendering apparatus 150 may determine whether transparency information is present with respect to each of the plurality of fragments. The object rendering apparatus 150 may transmit fragments for which transparency information is not present to the fragment shader 160, so that a general rendering process may be performed on the fragments for which transparency information is not present.

The object rendering apparatus 150 may extract transparency information from fragments for which transparency information is present. The object rendering apparatus 150 may store the extracted transparency information in a transparency buffer for each fragment.

In operation 420, the object rendering apparatus 150 may compare depth information of at least one fragment that is located in the same position of the frame, from among the plurality of fragments.

The plurality of fragments, which are received by the object rendering apparatus 150, may include fragments that are located in the same position of the frame. The object rendering apparatus 150 may extract depth information from fragments that include the same position information. The object rendering apparatus 150 may compare the extracted depth information and arrange fragments that include the same position information.

In operation 430, based on comparing of the depth information, the object rendering apparatus 150 may extract a first fragment that is located at a nearest depth, from among the fragments located in the same position.

In operation 440, the object rendering apparatus 150 may compare transparency information of the first fragment to preset transparency information. For example, the object rendering apparatus 150 may compare a transparency value of the first fragment to a preset transparency value.

In operation 450, based on a result of the comparing, the object rendering apparatus 150 may remove a second fragment that is located at a farther depth than the first fragment, from among at least one fragment that is located in the same position as the first fragment. If the transparency value of the first fragment is lower than the preset transparency value, the first fragment is opaque. Thus, the second fragment may have little effect on representing an object in a frame, and the object rendering apparatus 150 may not render the second fragment that is located in a farther depth than the first fragment. Accordingly, the object rendering apparatus 150 may remove the second fragment, and thus reduce an amount of operation in a subsequent rendering process.

In operation 460, based on a result of the comparing, the object rendering apparatus 150 may render the second fragment by using a preset rendering method.

If a transparency value of the first fragment is equal to or higher than a preset transparency value, the object rendering apparatus 150 may render the second fragment based on a preset rendering method. If the transparency value is equal to or higher than the preset transparency value, a result of rendering the second fragment may have an effect on representing an object in a frame. Thus, a preset rendering method may be used to perform rendering on the second fragment.

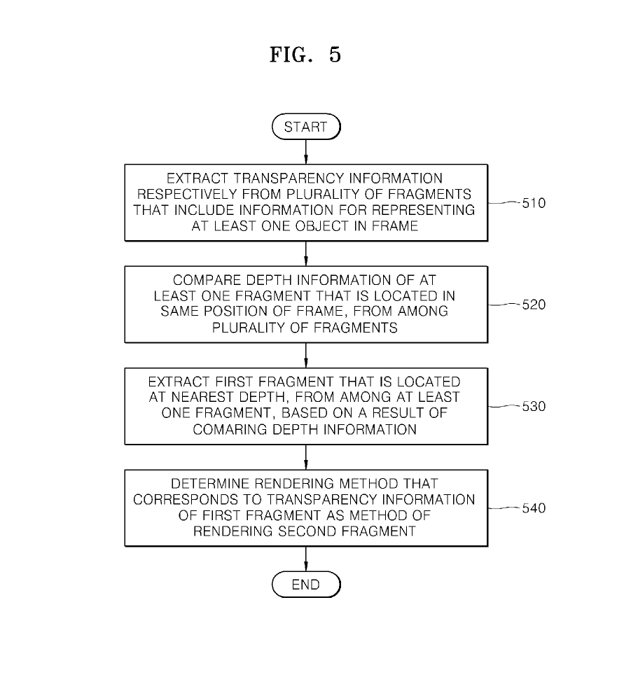

FIG. 5 is a diagram illustrating an example of a method of rendering fragments that are located in the same position in a frame, based on a rendering method that is classified according to transparency, which is performed by the object rendering apparatus 150. The operations in FIG. 5 may be performed in the sequence and manner as shown, although the order of some operations may be changed or some of the operations omitted without departing from the spirit and scope of the illustrative examples described. Many of the operations shown in FIG. 5 may be performed in parallel or concurrently.

In operation 510, the object rendering apparatus 150 may extract transparency information from a plurality of fragments that include information representing at least one object in a frame.

The object rendering apparatus 150 may determine whether transparency information is present with respect to each of the plurality of fragments. The object rendering apparatus 150 may transmit fragments for which transparency information is not present to the fragment shader 160 so that a general rendering process may be performed on the fragments for which transparency information is not present.

The object rendering apparatus 150 may extract transparency information from fragments whose transparency information is present. The object rendering apparatus 150 may store the extracted transparency information in a transparency buffer for each fragment.

In operation 520, the object rendering apparatus 150 may compare depth information of at least one fragment that is located in the same position of the frame, from among the plurality of fragments.

The plurality of fragments, which are received by the object rendering apparatus 150, may include fragments that are located in the same position of the frame. The object rendering apparatus 150 may extract depth information from fragments that include the same position information. The object rendering apparatus 150 may compare the extracted depth information between the fragments and arrange fragments that include the same position information.

In operation 530, based on the comparision of the depth information, the object rendering apparatus 150 may extract a first fragment that is located at a nearest depth, from among at least one fragment that is located in the same position.

In operation 540, the object rendering apparatus 150 may determine a rendering method that corresponds to transparency information of the first fragment, which is extracted from a plurality of rendering methods with respect to the predetermined fragment, as a method of rendering a second fragment. The plurality of rendering methods may be classified based on transparency information of a fragment that is located at a nearer depth than the predetermined fragment. The second fragment may be a fragment that is located at a farther depth than the first fragment, from among fragments located in the same position in a frame as the first fragment.

The object rendering apparatus 150 may classify a plurality of rendering methods, based on a transparency value of a fragment that is located at a nearer depth than the predetermined fragment.

If a transparency value of the fragment that is located in a nearer depth than the predetermined fragment is equal to or greater than 0 and less than 30, a first rendering method may be determined as a method of rendering the predetermined fragment. If a transparency value of the fragment that is located in a nearer depth than the predetermined fragment is equal to or greater than 30 and less than 70, a second rendering method may be determined as a method of rendering the predetermined fragment. If a transparency value of the fragment that is located in a nearer depth than the predetermined fragment is equal to or greater than 70 and equal to or less than 100, a third rendering method may be determined as a method of rendering the predetermined fragment.

From among fragments located at the same position in a frame, a fragment y may be located in a nearer depth than a fragment x. The object rendering apparatus 150 may determine a method of rendering the fragment x, based on a transparency value of the fragment y. For example, a transparency value of the fragment y may be 50, and thus, a transparency value of the fragment y corresponds to equal to or greater than 30 and less than 70. Thus, the object rendering apparatus 150 may determine the second rendering method as a method of rendering the fragment x.

The object rendering apparatus 150 may sum transparency values of fragments that is present in the same position of the frame, according to predetermined criteria. The object rendering apparatus 150 may determine a method of rendering at least one fragment that is present in the same position of the frame, based on a value that is obtained by the summing of the transparency values of fragments according to the predetermined criteria.

For example, fragments a, b, and c may be located in the same position of the frame. The fragment a may be located at a nearest depth, the fragment b may be located at a farther depth than the fragment a, and the fragment c may be located at a farther depth than the fragment b. A transparency value of the fragment a may be 70, and a transparency value of the fragment b may be 30. Since the fragment c is located in the farthest depth, a transparency value of the fragment c may not be taken into account when a rendering method is determined.

With regard to the object rendering apparatus 150, the transparency value of the fragment a is relatively high. Thus, a rendering method with high precision may be determined with regard to the fragment b. In the case of the fragment c, since the transparency value of the fragment a is 70, and the transparency value of the fragment b is 30, the fragment c may be covered by the fragment b, and thus may have a little effect on representing an object in the frame. Accordingly, with regard to the fragment c, a rendering method with relatively low precision may be determined.

A result of the comparing of the transparency values may be a basis for blending information of fragments that are located in the same position, which is performed by the fragment shader 170 shown in FIG. 1. For example, the fragment c may account for a small proportion in a process of blending information of fragments.

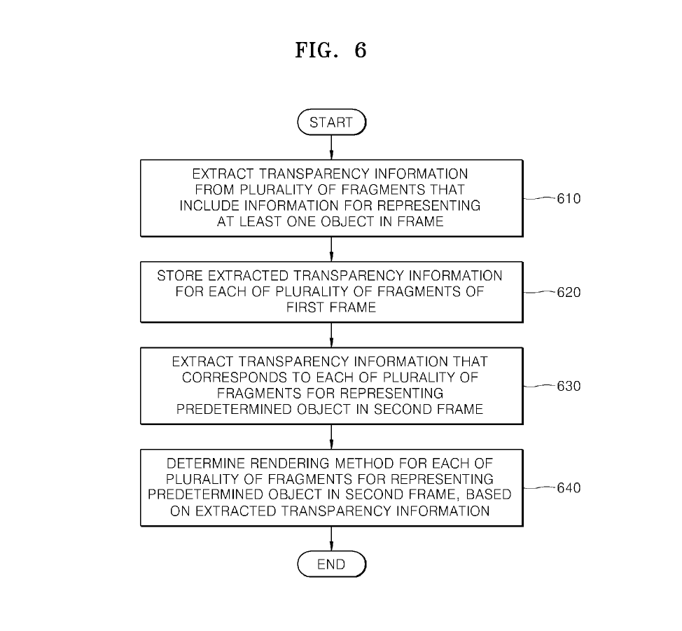

FIG. 6 is a diagram illustrating an example of a method of using transparency information of a current frame to render a fragment for representing a predetermined object in a next frame. The operations in FIG. 6 may be performed in the sequence and manner as shown, although the order of some operations may be changed or some of the operations omitted without departing from the spirit and scope of the illustrative examples described. Many of the operations shown in FIG. 6 may be performed in parallel or concurrently.

In operation 610, the object rendering apparatus 150 may extract transparency information from a plurality of fragments that include information for representing at least one object in a current first frame.

The object rendering apparatus 150 may determine whether transparency information is present with respect to each of the plurality of fragments. The object rendering apparatus 150 may transmit fragments whose transparency information is not present to the fragment shader 160, so that a general rendering process may be performed on the fragments whose transparency information is not present.

The object rendering apparatus 150 may extract transparency information from fragments whose transparency information is present.

In operation 620, the object rendering apparatus 150 may store the extracted transparency information in a transparency buffer for each fragment.

In operation 630, the object rendering apparatus 150 may extract transparency information, which corresponds to the plurality of fragments for representing a predetermined object in a second frame that is a next frame of the current first frame, from the transparency buffer.

in operation 640, the object rendering apparatus 150 may determine a method of rendering each of the plurality of fragments for representing the predetermined object in the second frame, based on the extracted transparency information. Based on a similarity between the plurality of frame, the object rendering apparatus 150 may use transparency information, which is extracted from a current frame, to render a fragment in a next frame.

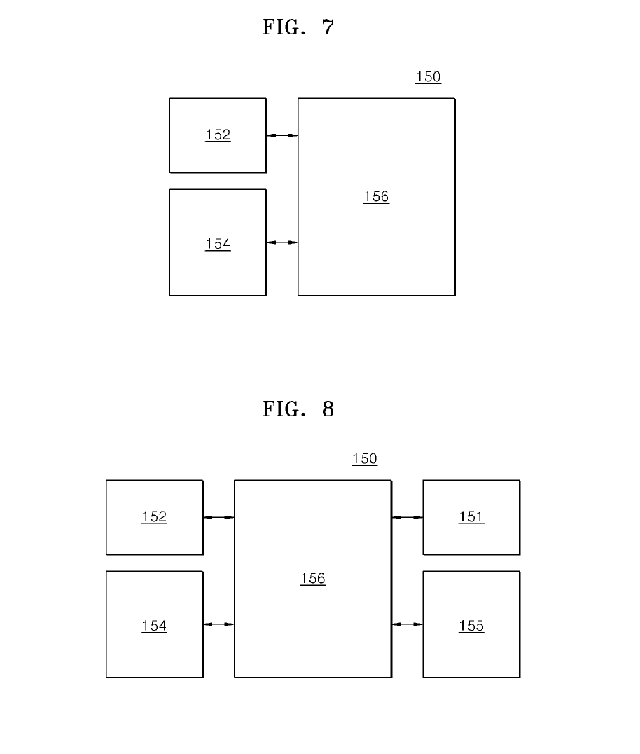

FIGS. 7 and 8 are block diagrams of the object rendering apparatus 150.

As shown in FIG. 7, the object rendering apparatus 150 may include a transparency information extraction unit 152, a depth information comparing unit 154, and a determination unit 156. While components related to the present example are illustrated in the object rendering apparatus 150 of FIG. 7, it is understood that those skilled in the art may include other general components.

For example, as shown in FIG. 8, the object rendering apparatus 150 may further include an input/output unit 151, and a transparency buffer 155, in addition to the transparency information extraction unit 152, the depth information comparing unit 154, and the determination unit 156.

The input/output unit 151 may obtain a plurality of fragments that include information for representing at least one object in a frame. The input/output unit 151 may obtain a plurality of fragments with respect to at least one object on which a geometry operation is performed. For example, the input/output unit 151 may obtain a plurality of fragments from the rasterizer 140 that is shown in FIG. 1. The input/output unit 151 may obtain a plurality of fragments that include information for representing an object in each frame, with respect to the plurality of frames.

The transparency information extraction unit 152 may extract transparency information from a plurality of fragments that include information to represent at least one object in a frame.

The transparency information extraction unit 152 may determine whether transparency information is present with respect to each of the plurality of fragments. The transparency information extraction unit 152 may control the input/output unit 151 so that a general rendering process may be performed on the fragments whose transparency information is not present. The input/output unit 151 may transmit fragments whose transparency information is not present to the fragment shader 160,

The transparency information extraction unit 152 may extract transparency information from fragments whose transparency information is present, and thus store the extracted transparency information in the transparency buffer 155 for each fragment. The transparency buffer 155 may include a space for storing transparency information for each fragment.

The depth information comparing unit 154 may compare depth information of at least one fragment that is located in the same position of the frame, from among the plurality of fragments.

The plurality of fragments, which are obtained by the input/output 151, may include fragments that are located in the same position of the frame. For example, with regard to objects that overlap with each other, fragments in an area in which the objects overlap with each other may include the same position information in the frame.

The depth information comparing unit 154 may extract depth information from fragments that include the same position information. The depth information comparing unit 154 may compare the extracted depth information and, as a result of the comparing, arrange fragments that include the same position information. For example, the depth information comparing unit 154 may arrange the fragments, which include the same position information, in an order of nearer depths of the fragments.

Based on the result of the comparing the depth information and the transparency information, the determination unit 156 may determine a method of rendering at least one fragment that is located in the same position.

Based on a result of the comparing of the depth information, the determination unit 156 may extract a first fragment that is located in a nearest depth from among at least one fragment that is located in the same position. The determination unit 156 may determine a method of rendering a second fragment that is located in a farther depth than the first fragment, based on transparency information of the first fragment.

For example, if the transparency of the first fragment is equal to or less than a preset value, the determination unit 156 may remove the second fragment. In other words, if the transparency of the first fragment is equal to or less than the preset value, the determination unit 156 may not render the second fragment.

As another example, the determination unit 156 may determine a rendering method that corresponds to transparency information of the first fragment, which is extracted from a plurality of rendering methods, as a method of rendering a second fragment. The the plurality of rendering methods may be classified based on transparency information of a fragment that is located at a nearer depth than the predetermined fragment. The second fragment may be a fragment that is located in a farther depth than the first fragment from among fragments that are located in the same position in a frame as the first fragment. The determination unit 156 may classify a plurality of rendering methods, based on a transparency value of a fragment that is located in a nearer depth than the predetermined fragment.

The determination unit 156 may sum transparency values of fragments whose transparency information is present, with respect to at least one fragment that is located in the same position of the frame, based on predetermined criteria. The determination unit 156 may determine a method of rendering at least one fragment that is located in the same position of the frame, based on a value that is obtained by the summing of the transparency values according to the predetermined criteria.

The determination unit 156 may control the input/output unit 151 so as to store transparency information, which is extracted with respect to a plurality of fragments in a first frame, which is a current frame, in the transparency buffer 155 for each fragment. The determination unit 156 may determine a rendering method with respect to the plurality of fragments that represents a predetermined object in a second frame that is a next frame, based on the stored transparency information of the first frame. The determination unit 156 may control the transparency information extraction unit 152 to extract transparency information of the first frame from the transparency buffer 155, in order to determine a method of rendering each of a plurality of fragments in the second frame.

FIG. 9 is a diagram illustrating an example of a method of rendering a plurality of fragments in a next frame based on transparency information of a current frame, which is performed by the object rendering apparatus 150. The operations in FIG. 9 may be performed in the sequence and manner as shown, although the order of some operations may be changed or some of the operations omitted without departing from the spirit and scope of the illustrative examples described. Many of the operations shown in FIG. 9 may be performed in parallel or concurrently.

In operation 910, the object rendering apparatus 150 may extract transparency information from a plurality of fragments that include information for representing at least one object in a first frame.

The object rendering apparatus 150 may store the extracted transparency information in a separate transparency buffer. For example, the object rendering apparatus 150 may classify a plurality of spaces for a plurality of fragments that are included in the first frame, and store transparency information of fragments that correspond to the space.

In operation 920, based on each of the extracted transparency information, the object rendering apparatus 150 may determine a rendering method for each of the plurality of fragments that include information about at least one object in a second frame.

Based on a similarity between the plurality of frame, the object rendering apparatus 150 may use transparency information, which is extracted from a current frame, to render a fragment in a next frame.

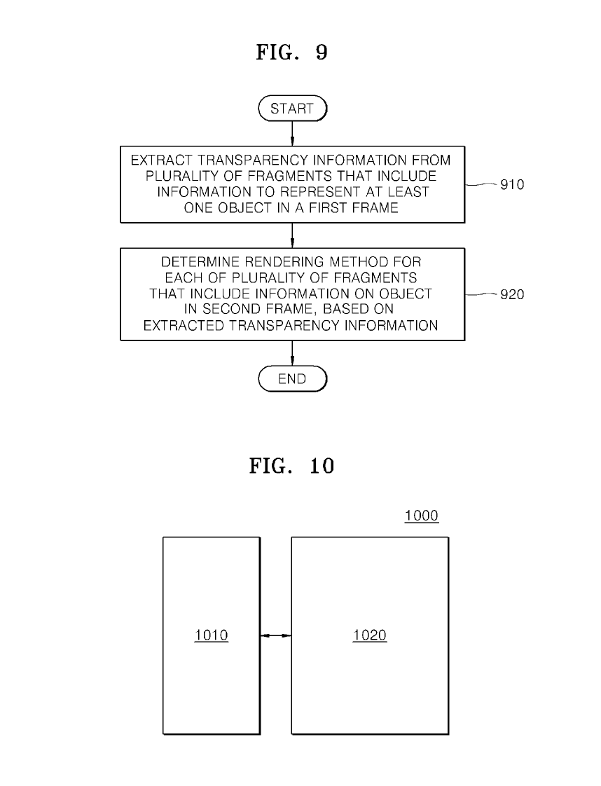

FIG. 10 is a block diagram of an object rendering apparatus 1000. While components related to the present example are illustrated in the object rendering apparatus 1000 of FIG. 10, it is understood that those skilled in the art may include other general components.

Referring to FIG. 10, the object rendering apparatus 1000 includes a transparency information extraction unit 1010 and a determination unit 1020.

The transparency information extraction unit 1010 may extract transparency information from a plurality of fragments that include information for representing at least one object in a frame.

The determination unit 1020 may determine a method of rendering the plurality of fragments that include information to represent the predetermined object in a second frame, based on the extracted transparency information.

The processes, functions, and methods described above can be written as a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device that is capable of providing instructions or data to or being interpreted by the processing device. The software also may be distributed over network coupled computer systems so that the software is stored and executed in a distributed fashion. In particular, the software and data may be stored by one or more non-transitory computer readable recording mediums. The non-transitory computer readable recording medium may include any data storage device that can store data that can be thereafter read by a computer system or processing device. Examples of the non-transitory computer readable recording medium include read-only memory (ROM), random-access memory (RAM), Compact Disc Read-only Memory (CD-ROMs), magnetic tapes, USBs, floppy disks, hard disks, optical recording media (e.g., CD-ROMs, or DVDs), and PC interfaces (e.g., PCI, PCI-express, WiFi, etc.). In addition, functional programs, codes, and code segments for accomplishing the example disclosed herein can be construed by programmers skilled in the art based on the flow diagrams and block diagrams of the figures and their corresponding descriptions as provided herein.

The apparatuses and units described herein may be implemented using hardware components. The hardware components may include, for example, controllers, sensors, processors, generators, drivers, and other equivalent electronic components. The hardware components may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The hardware components may run an operating system (OS) and one or more software applications that run on the OS. The hardware components also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a hardware component may include multiple processors or a processor and a controller. In addition, different processing configurations are possible, such a parallel processors.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A rendering method, comprising:
extracting transparency information, at a object rendering apparatus, from a plurality of fragments, which comprise information representing at least one object in a frame;
comparing depth information of at least one fragment, from among the plurality of fragments, located at a position of the frame; and
determining a rendering of at least one fragment that is located in the position based on the comparison of the depth information and the transparency information.

2. The rendering method of claim 1, wherein the determining of the rendering comprises:
extracting a first fragment that is located at a nearest depth from among the at least one fragment that is located in the position based on the comparison of the depth information; and
determining a rendering of a second fragment that is located at a farther depth than the first fragment based on transparency information of the first fragment.

3. The rendering method of claim 2, wherein the determining of the rendering of the second fragment comprises removing the second fragment in response to transparency of the first fragment being equal to or less than a value.

4. The rendering method of claim 2, wherein the determining of the rendering of the second fragment comprises selecting the rendering of the second fragment from among a plurality of rendering methods,
wherein the plurality of rendering methods are classified based on transparency information of a fragment that is located in a nearer depth than the predetermined fragment.

5. The rendering method of claim 1, further comprising storing the extracted transparency information in a transparency buffer for each fragment.

6. The rendering method of claim 1, further comprising obtaining a plurality of fragments, which comprise information for representing at least one object in a frame.

7. The rendering method of claim 1, further comprising:
storing the extracted transparency information in a transparency buffer as transparency information for each of the plurality of fragments in the frame; and
determining a rendering of each of a plurality of fragments, which represent the object in a second frame based on the stored transparency information.

8. The rendering method of claim 7, further comprising:
extracting transparency information, which corresponds to the plurality of fragments for representing the object in the second frame, from the transparency buffer; and
determining a method of rendering each of the plurality of fragments representing the object in the second frame based on the extracted transparency information.

9. The rendering method of claim 1, wherein the determining of the rendering comprises:
extracting a first fragment and second fragment that is located at a nearest depth from among the at least one fragment that is located in the position based on the comparison of the depth information; and
determining a rendering of a third fragment that is located at a farther depth than the first fragment and the second fragment based on a sum of transparency information of the first fragment and the second fragment.

10. A non-transitory computer-readable storage medium having stored thereon a computer program, which when executed by a computer, performs the method of claim 1.

11. An rendering method, comprising:
extracting transparency information, at a object rendering apparatus, from a plurality of fragments that comprise information representing at least one object in a frame;
determining rendering of each of a plurality of fragments that comprise information representing a object in a second frame based on each of the extracted transparency information.

12. A non-transitory computer-readable storage medium having stored thereon a computer program, which when executed by a computer, performs the method of claim 10.

13. An rendering apparatus, comprising:
a transparency information extractor configured to extract transparency information from a plurality of fragments, which comprise information to represent at least one object in a frame;
a depth information comparer configured to compare depth information of at least one fragment, from among the plurality of fragments, located at a position of the frame; and
a determiner configured to determine a rendering of at least one fragment that is located in the same position based on the comparison of the depth information and the transparency information.

14. The rendering apparatus of claim 13, wherein the determiner is further configured to:
extract a first fragment that is located in a nearest depth, from among the at least one fragment based on the result of the comparing of the depth information; and
determine rendering of a second fragment that is located at a farther depth than the first fragment based on transparency information of the first fragment.

15. The rendering apparatus of claim 14, wherein the determiner is further configured to remove the second fragment in response to the transparency of the first fragment being equal to or less than a value.

16. The rendering apparatus of claim 14, wherein the determiner is further configured to select the rendering of the second fragment from among a plurality of rendering methods, and
the plurality of rendering methods are classified based on transparency information of a fragment that is located in a nearer depth than the predetermined fragment.

17. The rendering apparatus of claim 13, further comprising a transparency buffer configured to store the extracted transparency information for each fragment.

18. The rendering apparatus of claim 13, further comprising an input/output apparatus configured to obtain a plurality of fragments that comprise information for representing at least one object in a frame.

19. The rendering apparatus of claim 13, wherein the determiner is further configured to:
control a transparency buffer configured to store the extracted transparency information as transparency information for each of the plurality of fragments in the frame; and
determine a method of rendering each of a plurality of fragments representing the object in a second frame based on the stored transparency information.

20. The rendering apparatus of claim 19, wherein the determiner is further configured to:
control the transparency information extractor to extract transparency information, which corresponds to the plurality of fragments for representing the object in the second frame, from the transparency buffer; and
determine a method of rendering each of the plurality of fragments for representing the object in the second frame based on the extracted transparency information.

21. An rendering apparatus, comprising:
a transparency information extractor configured to extract transparency information respectively from a plurality of fragments that comprise information for representing at least one object in a frame; and
a determiner configured to determine rendering a plurality of fragments that comprise information for representing a object in a second frame based on each of the extracted transparency information.
